(19) United States
(12) Patent Application Publication
(10) Pub. No.: US 2019/0132130 A1
(43) Pub. Date: May 2, 2019

(54) Authoring and Embedding Blockchain Based Smart Contracts in B2B Contract Managements Systems

(71) Applicant: SAP SE, Walldorf (DE)

(72) Inventors: Hemanth Rajeswari Anantha, Bangalore (IN); Kiran Prashanth Kulkarni, Bangalore (IN); Abhishek Chaturvedi, Bangalore (IN); Debashis Banerjee, Bangalore (IN); Panish Ramakrishna, Bangalore (IN)

(21) Appl. No.: 15/796,204

(22) Filed: Oct. 27, 2017

(51) Int. Cl. H04L 9/32; H04L 29/06; G06F 9/44; G06F 9/45; G06F 9/445; G06F 17/30; G06Q 10/10

(52) U.S. Cl. CPC H04L 9/3213; H04L 63/107; G06F 8/30; G06Q 10/107; G06F 8/60; G06F 17/30345; G06F 8/41

(57) ABSTRACT

Disclosed herein are system, method, and computer program product embodiments for converting a static contract clause into an operationalizing contract clause on a blockchain. An embodiment operates by converting the static contract clause to an operationalized contract clause having a trigger and an action. The embodiment generates executable code for a blockchain based on the trigger and the action. The embodiment deploys the executable code on a block in the blockchain. The embodiment then executes the action in the executable code in the blockchain in response to receiving the trigger.

### BACKGROUND

Entities (e.g., businesses, organizations, and people) often establish contracts with other entities. For example, a business may establish a contract with a supplier to buy a particular number of goods at a particular price. Traditionally, a business would create a contract containing various contract clauses. These contract clauses would define the duties, rights, and privileges of each party wider the contract.

But an entity may wish to operationalize a contract. A operationalized contract (e.g., a smart contract) is a contract in digital form that automatically self-executes one or more contract clauses in response to various conditions. For example, a operationalized contract may automatically transfer a specific amount of money from a buyer to a supplier in response to the buyer issuing a purchase order for a particular number of goods at a particular price.

Traditional contract management systems often support operationalized contracts. But they suffer from several problems. First, these contract management systems often store the contracts at a central location. This may create security issues. This may further require the contract management systems to have increased storage and computing power. Second, these operationalizing contracts may be unverifiable and susceptible to modification.

### BRIEF DESCRIPTION OF THE DRAWINGS

The accompanying drawings are incorporated herein and form a part of the specification.

FIG. 1 is a block diagram of a contract management system that converts a static contract into a operationalized contract on a blockchain, according to some embodiments.

FIG. 2 illustrates an executable code generation system for generating executable code for a blockchain to perform one or more actions for a contract clause of a static contract, according to some embodiments.

FIG. 3 is a flowchart illustrating a process for converting a static contract into a operationalized contract on a blockchain, according to some embodiments.

FIG. 4 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for converting a static contract into a operationalized contract stored on a blockchain. Such embodiments provide several benefits over traditional contract management systems. First, creating a operationalized contract on a blockchain guarantees the contract's clauses will be enforced. This is because a blockchain is inherently resistant to modification of its data. Second, creating a operationalized contract for storage on a blockchain reduces the security risk associated with storing the operationalized contract in a central location of a contract management system. Finally, creating a operationalized contract on a blockchain reduces a contract management system's storage and computing power requirements. This is because the blockchain may be distributed across a computer network.

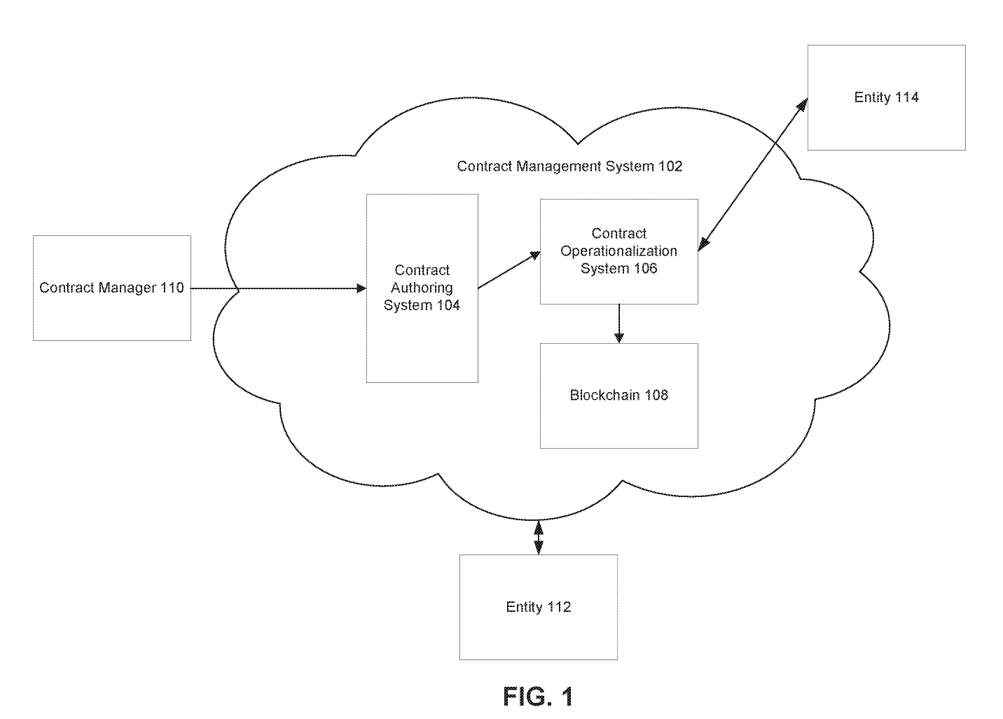

FIG. 1 is block diagram of a contract management system 102 that converts a static contract into a operationalized contract on a blockchain 108, according to an example embodiment. Contract management system 102 may be a collection of computer software programs that control the organization, storage, execution, and retrieval of contract data. In some embodiments, contract management system 102 may be implemented on a cloud computing platform. Contract management system 102 includes contract authoring system 104, contract operationalizing system 106, and blockchain 108.

In some embodiments, contract authoring system 104 may be a collection of computer software programs that enable a contract manager 110 to create a static contract.

In some embodiments, contract manager 110 may a person, or collection of persons, who author a static contract on behalf of two or more entities (e.g., businesses, organizations, people, etc.). For example, contract manager 110 may author a contract between entity 112 and entity 114 in FIG. 1.

In some embodiments, contract authoring system 104 may store a static contract in a contract database. In some embodiments, the contract database may be a relational database. A relational database may organize data as a set of database tables from which data can be accessed or reassembled in different ways without having to reorganize the database tables. As would be appreciated by a person of ordinary skill in the art, the contract database may be various other types of databases.

In some embodiments, a static contract may an electronic contract document (e.g., Microsoft Word document, Portable Document Format (PDF) document, or various other types of electronic contract document as would be appreciated by a person of ordinary skill in the art).

In some embodiments, a static contract may include one or more contract clauses. A contract clause may define the duties, rights, and privileges of each entity under the contract. In some embodiments, a contract clause may be a block of text in the static contract (e.g., a paragraph, table, page, or exhibit). A static contract, unlike a operationalized contract, may not include self-executing contract clauses.

In some embodiments, contract manager 110 may manually enter a contract clause and add it to the static contract. In some other embodiments, contract manager 110 may select a contract clause stored in a contract clause library. A contract clause stored in the contract clause library may be predefined. Contract manager 110 may then add the predefined contract clause to the static contract. In some embodiments, contract manager 110 may modify a contract clause selected from the contract clause library prior to adding it to the static contract.

In some embodiments, contract manager 110 may define one or more contract attributes for the static contract. In some embodiments, a contract attribute may be a field that defines a data attribute of the contract. In some embodiments, contract authoring system 104 may provide one or more predefined fields (e.g., contract amount, supplier, effective data, expiration date, etc.). In some other embodiments, contract authoring system 104 may allow contract manager 110 to define one or more custom fields for data attributes of the contract.

In some embodiments, contract manager 110 may want to operationalize a static contract. For example, in some embodiments, contract manager 110 may want a particular contract clause in the static contract to be fully executed or enforced without human interaction. This may be referred to as “operationalizing” the static contract. For example, contract manager 110 may want to automatically enforce a contract clause between entity 112 (e.g., a buyer) and entity 114 (e.g., a supplier). For example, the contact clause may require that entity 112 (e.g., a buyer) transfer a particular amount of money to entity 114 (e.g., a supplier) in response to a purchase order from entity 112 for a particular number of goods (e.g., laptops, mobile phones, etc.) at a particular price.

In some embodiments, contract manager 110 may use contract operationalizing system 1-106 to operationalize a static contract. For example, in some embodiments, contract manager 110 may define one or more triggers and or one or more conditions for a contract clause. In some embodiments, contract operationalizing system 106 may control when a contract clause is executed based on the one or more triggers. In some embodiments, contract operationalizing system 106 may control how to enforce and execute the contract clause based on the one or more conditions. In some embodiments, the one or more conditions may be based on one or more contract attributes defined for the static contract (e.g., effective data, expiration date, etc.).

In some embodiments, contract manager 110 may further define one or more actions to perform for a contract clause. In some embodiments, contract operationalizing system 106 may automatically execute the one or more actions for the contract clause. In some other embodiments, contract operationalizing system 106 may automatically execute the one or more actions based on one or more conditions defined for the contract clause. For example, in some embodiments, contract operationalizing system 106 may transfer a particular amount of money to entity 114 (e.g., a supplier) in response to a purchase order from entity 112 for a particular number of goods (e.g., laptops, mobile phones, etc.) at a particular price. In some embodiments, the one or more actions may be based on one or more contract attributes defined for the static contract (e.g., quantity, price, supplier account, etc.).

In some embodiments, contract operationalizing system 106 may directly enforce a contract clause for an operationalized contract. But this may suffer from several problems. First, this may create security issues. Second, this may require the contract management system 102 to have increased storage and computing power. Finally, such an operationalized contract may be unverifiable and susceptible to modification.

In some other embodiments, contract operationalizing system 106 may execute one or more actions associated with a contract clause for an operationalized contract on blockchain 108. In some embodiments, contract operationalizing system 106 may continue to directly execute other actions associated with the contract clause. For example, contract operationalizing system 106 may issue purchase orders (POs), send invoices, and perform various other actions as would be appreciated by a person of ordinary skill in the art.

In some embodiments, blockchain 108 is a blockchain containing one or more blocks which are linked and secured using cryptography. In some embodiments, blockchain 108 may be private to contract management system 202. In some other embodiments, blockchain 108 may be a publicly accessible blockchain. As would be appreciated by a person of ordinary skill in the art, blockchain 108 may be implemented using various blockchain distributing computing platforms (e.g., Ethereum Blockchain).

In some embodiments, a block in blockchain 108 may contain a hash pointer as a link to a previous block, a timestamp, and transaction data. In some embodiments, the transaction data may include executable code. In some embodiments, blockchain 108 may execute this executable code. As would be appreciated by a person of ordinary skill in the art, this executable code may written using various programming languages (e.g., Java, Solidity, Serpent, LLL, Muta, etc.). In some embodiments, blockchain may support different programming languages based on its blockchain distributing computing platform.

In some embodiments, contract operationalizing system 106 may execute one or more actions associated with a contract clause for an operationalized contract on blockchain 108. First, in some embodiments, contract operationalizing system 106 may execute a payment transfer action. In some embodiments, contract operationalizing system 106, in response to a trigger, may execute the payment transfer action based on a timed priced condition associated with a contract clause. In other embodiments, contract operationalizing system 106, in response to a trigger, may execute the payment transfer action based on a location based condition associated with a contract clause. As would be appreciated by a person of ordinary skill in the art, contract operationalizing system 106 may execute the payment transfer action based on various other types of conditions.

Second, in some embodiments, contract operationalizing system 106 may send an email in response to a trigger associated with a contract clause. Third, contract operationalizing system 106, in response to a trigger, may execute a function of an external software program via an application programming interface (API) of the external software program. For example, in some embodiments, contract operationalizing system 106 may adjust a product's inventory in an inventory management system in response to a PO trigger associated with a contract clause.

In some embodiments, contract operationalizing system 106 may generate executable code to perform one or more actions associated with a contract clause. In some embodiments, contract operationalizing system 106 may store this executable code on a block in blockchain 108 for execution. By way of example, the actions of performing a payment transfer, sending an email, and adjusting a product's inventory in an inventory management system are discussed. However, as would be appreciated by a person of ordinary skill in the art, contract operationalizing system 106 may similarly generate executable code for various other actions associated with a contract clause.

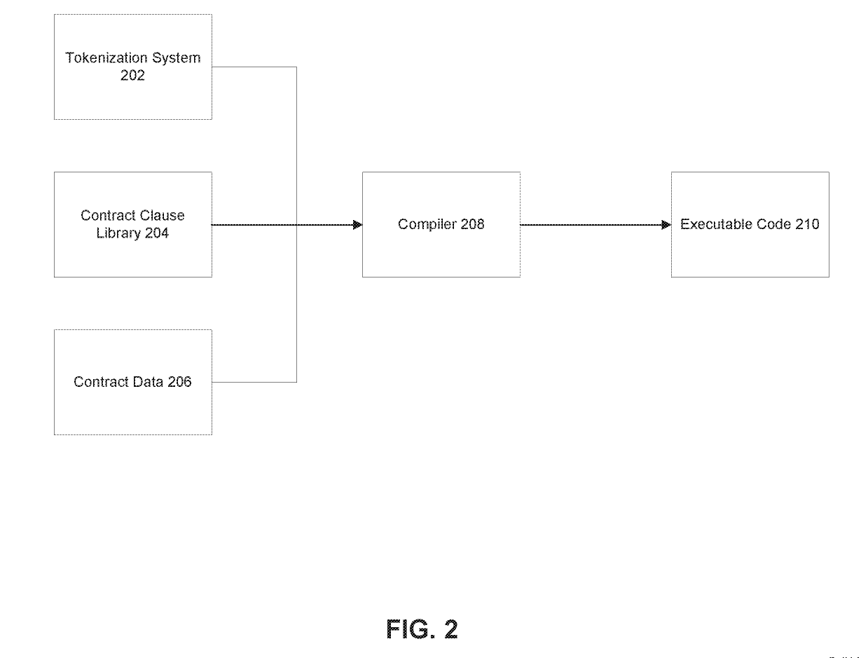

FIG. 2 illustrates executable code generation system 200 for generating executable code for blockchain 108 to perform one or more actions for a contract clause of a static contract, according to an example embodiment. By way of example, FIG. 2 is discussed with respect to a static contract between entity 112 (e.g., a buyers and entity 114 (e.g., a supplier) for entity 112 to buy 1,000 laptops.

In FIG. 2, executable code generation system 200 includes tokenization system 202, contract clause library 204, contract data 206, and compiler 208. Executable generation system 200 generates executable code 210 for execution on blockchain 108.

In some embodiments, contract data 206 may store one or more contract attributes defined for a static contract. In some embodiments, contract manager 110 may have defined the one or more contract attributes for the static contract. For example, in the static contract of FIG. 2, contract data 206 may include a contract attribute (e.g., “quantity”) holding the number of laptops to buy (e.g., “1,000”), a contract attribute (e.g., “price”) holding the price of a laptop (e.g., “$750”), and a contract attribute (e.g., “supplier”) holding the name of a supplier (e.g., “Acme”).

In some embodiments, contract clause library 204 may store one or more contract clauses. In some embodiments, these contract clauses can be added to a static contract. In some embodiments, a contract clause in contract clause library 204 may define a code template for performing one or more actions associated with the contract clause. For example, in some embodiments, the code template may perform a payment transfer, send an email, and/or adjust a product's inventory in an inventory management system. In some embodiments, a contract clause may perform the actions associated with the contract clause based on a trigger (e.g., a PO being submitted).

In some embodiments, the code template may include one or more tokens (e.g., reference identifiers) and one or more value placeholders. In some embodiments, a token may represent a condition variable of interest for a contract clause (e.g., the current month). In some embodiments, a value placeholder may represent a contract term for a contract clause (e.g. price).

In some embodiments, compiler 208 generates executable code 210 representing a self-executing contract clause using tokenization system 202, contract clause library 204, and contract data 206. In some embodiments, compiler 208 replaces a token in a code template associated with the contract clause with code that maps to a condition variable of interest. For example, in some embodiments, compiler 208 replaces a token in a code template with code that maps the token to a condition variable of interest using tokenization system 202.

In some embodiments, tokenization system 202 stores a predefined set of tokens that are mapped to corresponding condition variables of interest. For example, tokenization system 202 may map a “current_month” token to a condition variable holding the actual current month.

In some embodiments, compiler 208 replaces a value placeholder in a code template associated with the contract clause with a contract attribute in contract data 206. For example, for the static contract of FIG. 2, compiler 208 may replace a “supplier” value placeholder in a code template for a contract clause with “ACME”, the value of the “supplier” contract attribute.

As discussed above, a contract clause in contract clause library 204 may define a code template for performing, for example, three actions: a payment transfer, sending an email, and adjusting a product's inventory in an inventory management system. As would be appreciated by a person of ordinary skill in the art, code template may be defined for various other types of actions. By way of example, compiler 208's generation of executable code 210 for each of these three actions is discussed with respect to the static contract between entity 112 (e.g., a buyer) and entity 114 (e.g., a supplier) for entity 112 to buy 1,000 laptops.

In some embodiments, compiler 208 may generate executable code 210 for performing a payment transfer. In some embodiments, executable code 210 may perform the payment transfer using Bitcoin, Ethereum, or another cryptocurrency. As would be appreciated by a person of ordinary skill in the art, executable code 210 may perform the payment transfer using various other electronic methods and currencies.

In some embodiments, compiler 208 may generate executable code 210 for performing a payment transfer based on a price condition. For example, a different price per unit may be set for each of month of the contract term. In some embodiments, a price per unit may be set for each of month based on a code template associated with the contract clause and contract data 206. In some other embodiments, compiler 208 may generate blockchain code 210 for performing a payment transfer based on a location condition. For example, a different price per unit may be set for each location of a supplier. In some embodiments, a price per unit may be set for each location based on a code template associated with the contract clause and contract data 206.

In some embodiments, compiler 208 may generate blockchain code 210 for performing a payment transfer based on a price condition. Compiler 208 may generate executable code 210 using a code template for a contract clause. The code template may specify one or more conditional price rules. In some embodiments, contract manager 110 may define the one or more specific price values for the conditional price rules using contract attributes stored in contract data 206.

For example, in some embodiments, compiler 208 may replace one or more tokens and one or more value placeholders in the conditional price rules. In some embodiments, the one or more value placeholders may be replaced with one or more contract attributes stored in contract data 206.

By way of example, for the static contract of FIG. 2, a contract clause may specify the price for a laptop every month of the contract: $750 in January, $700 in February, $650 in March, $600 in April, $550 in May, and $500 in June. In order to generate the corresponding blockchain code 210, compiler 208 may select a code template associated with the contract clause.

For example, the code template may specify the following rule: “if <current_month>=<month> then pay requested_quantity*<month_price> to <supplier>”. Compiler 208 may generate a rule for each “(month, price)” pair defined by the contract attributes (e.g., defined by contract manager 110) in contract data 206. For example, for January, compiler 208 may generate the following rule: “if <current_month>=“January” then pay requested_quantity*“$750” to “ACME”.

For a token in the code template, in some embodiments, compiler 208 may replace the token with code that retrieves the corresponding actual value at the time of execution using tokenization system 202. For example, compiler 208 may replace the “<current_month=” token with code that retrieves the actual current month at the time of execution using tokenization system 202.

For an input variable (e.g., “requested_{—} quantity”) in the code template, in some embodiments, contract operationalization system 106 may assign an input argument to the input variable at the time of execution. For example, if entity 112 (e.g., a buyer) issues a purchase order for 200 laptops, contract operationalization system 106 may pass the value “200” as an input argument to the “requested_quantity” input variable in executable code 210 for execution.

In some other embodiments, compiler 208 may generate executable code 210 for performing a payment transfer based on a location condition. Compiler 208 may generate executable code 210 using a code template for a contract clause. The code template may specify one or more conditional price rules. Compiler 208 may replace one or more tokens and one or more value placeholders in the conditional price rules.

By way of example, for the static contract of FIG. 2, a contract clause may specify the price for a laptop from different supplier locations: $750 for a United States supplier, $650 for Chinese supplier, and $600 for Indian supplier. In order to generate the corresponding executable code 210, compiler 208 may select a code template associated with the contract clause that specifies various location condition rules. Compiler 208 may then replace one or more tokens and one or more value placeholders in the location condition rules. As would be appreciated by a person of ordinary skill in the art, compiler 208 may perform this replacement process similarly to that described above for a payment transfer based on price condition.

In some other embodiments, compiler 208 may generate executable code 210 for sending an email to stakeholders in response to a PO. Compiler 208 may generate the executable code 210 using a code template for a contract clause that specifies who, when, and what to email. The code template may specify one or more email sending rules. Compiler 208 may then replace one or more tokens and one or more value placeholders in the sending rules. For example, in some embodiments, compiler 208 may replace the who, when, and what value placeholders with contract attributes defined in contract data 206. As would be appreciated by a person of ordinary skill in the art, compiler 208 may perform this replacement process similarly to that described above for a payment transfer based on price condition.

In some other embodiments, compiler 208 may generate executable code 210 for issuing a request to an external application using an API of the external application. For example, compiler 208 may generate executable code 210 that issues a request to adjust a product's inventory in an inventory management system in response to a PO for the product. Compiler 208 may generate the executable code 210 using a code template for a contract clause that specifies the particular inventory adjustment to make using a particular API for a particular inventory management system. The code template may specify one or more inventory adjustment rules. Compiler 208 may then replace one or more tokens and one or more value placeholders in the inventory adjustment rules. For example, in some embodiments, compiler 208 may replace the value placeholders in the inventory adjustment rules with contract attributes defined in contract data 206. As would be appreciated by a person of ordinary skill in the art, compiler 208 may perform this replacement process similarly to that described above for a payment transfer based on price condition.

In some embodiments, contract operationalization system 106 may deploy the generated executable code 210 to blockchain 108. As would be appreciated by a person of ordinary skill in the art, contract operationalization system 106 may deploy the generated executable code 210 to blockchain 108 using the various standard mechanisms of the underlying blockchain distributing computing platform.

In some embodiments, contract management system 102 may execute blockchain code 210 on blockchain 108 in response to various triggers associated with a contract clause. As would be appreciated by a person of ordinary skill in the art, different triggers may be associated with different contract clauses for a contract. For example, in some embodiments, contract management system 102 may execute blockchain code 210 for performing a payment transfer based on a price condition in response to entity 112 (e.g., a buyer) issuing a PO to entity 114 (e.g., a supplier).

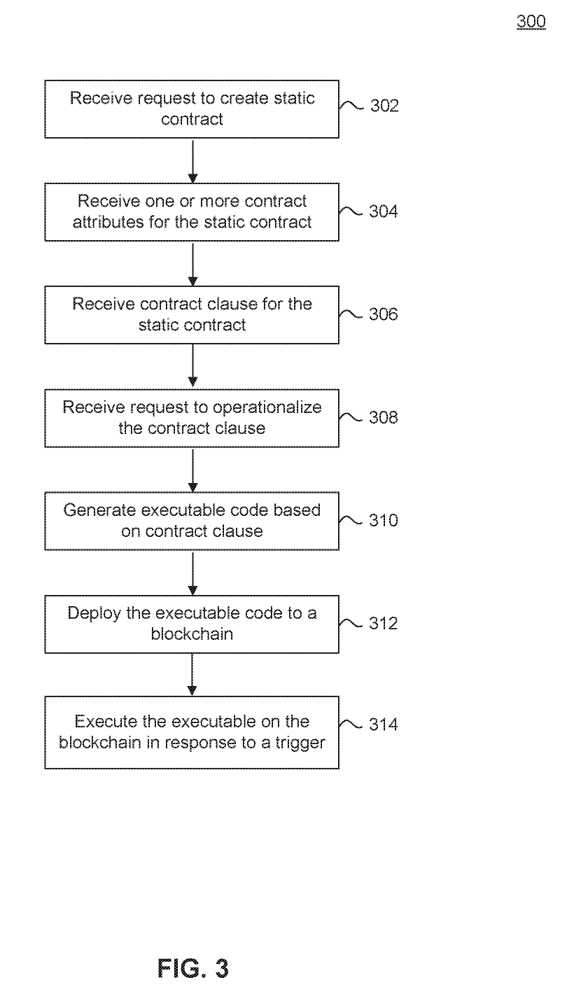

FIG. 3 is a flowchart for a method 300 for converting a static contract into a operationalized contract on a blockchain, according to an embodiment. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIGS. 1 and 2. However method 300 is not limited to those example embodiments.

In 302, contract authoring system 104 receives a request to create a static contract from contract manager 110. In some embodiments, the static contract may an electronic contract document (e.g., Microsoft Word document, Portable Document Format (PDF) document, or various other types of electronic contract document as would be appreciated by a person of ordinary skill in the art).

In 304, contract authoring system 104 receives one or more contract attributes defined for the static contract by contract manager 110. In some embodiments, a contract attribute may be a field that defines a data attribute of the contract. In some embodiments, contract authoring system 104 may provide one or more predefined fields (e.g., contract amount, supplier, effective data, expiration date, etc.). In some other embodiments, contract authoring system 104 may allow contract manager 110 to define one or more custom fields for data attributes of the static contract.

In 306, contract operationalizing system 106 receives a request to add a contract clause to the static contract by contract manager 110. A contract clause may define the duties, rights, and privileges of each entity under the contract. In some embodiments, contract manager 110 may define the contract clause manually. In some other embodiments, contract manager 110 may add the contract clause from contract clause library 204. In some embodiments, the contract clause may have an associated code template.

In 308, contract operationalizing system 106 receives a request to operationalize the contract clause from contract manager 110. In some embodiments, contract manager 110 may define one or more triggers associated with the contract clause. In some embodiments, the one or more triggers may be based on the code template associated with the contract clause. In some embodiments, contract operationalizing system 106 may control when the contract clause is executed based on the one or more triggers.

In some embodiments, contract manager 110 may define one or more conditions associated with the contract clause. In some embodiments, the one or more conditions may be based on the code template associated with the contract clause. In some embodiments, the one or more conditions may utilize one or more contract attributes defined for the static contract (e.g., effective data, expiration date, etc.).

In some embodiments, contract manager 110 may define one or more actions to perform for a contract clause. In some embodiments, the one or more actions may be based on the code template associated with the contract clause. In some embodiments, an action may be a payment transfer action based on a timed priced condition. In some embodiments, an action may be a payment transfer action based on a location based condition. In some embodiments, an action may be sending an email to stakeholders in response to a condition. In some embodiments, an action may be executing a function of an external software program via an API of the external software program. For example, in some embodiments, the action may execute a function to adjust a product's inventory in an inventory management system in response to a PO.

In 310, compiler 208 generates executable code (e.g., executable code 210) for blockchain 108 based on the contract clause. In some embodiments, compiler 208 replaces a token in a code template for the contract clause with code that maps to a condition variable of interest. For example, in some embodiments, compiler 208 replaces a token in the code template associated with the contract clause with code that maps the token to a condition variable of interest using tokenization system 202. In some embodiments, compiler 208 replaces a value placeholder in the code template for the contract clause with a contract attribute in contract data 206.

In 312, contract operationalizing system 106 deploys the executable code to blockchain 108. As would be appreciated by a person of ordinary skill in the art, contract operationalization system 106 may deploy the executable code to blockchain 108 using the various standard mechanisms of the underlying blockchain distributing computing platform.

In 314 contract management system 102 executes the executable code on blockchain 108 in response to a trigger. As would be appreciated by a person of ordinary skill in the art, different triggers may be associated with different contract clauses for a contract. For example, in some embodiments, contract management system 102 may execute executable code 210 for performing a payment transfer based on a price condition in response to entity 112 (e.g., a buyer) issuing a PO to entity 114 (e.g., a supplier). In some embodiments, for an input variable in the code template for the contract clause, contract operationalization system 106 may assign an input argument to the input variable at the time of execution.

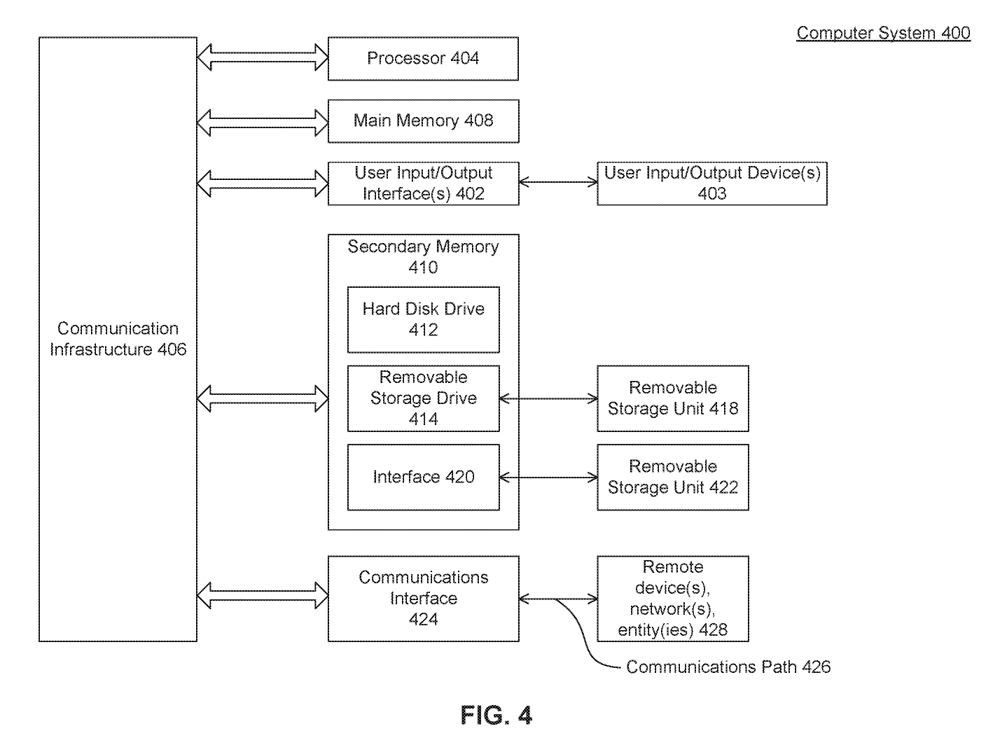

Various embodiments may be implemented, for example, using one or more well-known computer systems, such as computer system 400 shown in FIG. 4, One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache, Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk. DVD, optical storage disk, and/ any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, comprising:
converting, by at least one processor, a static contract clause to an operationalized contract clause comprising a trigger and an action;
generating, by the at least one processor, executable code for a blockchain based on the trigger and the action;
deploying, by the at least one processor, the executable code on a block in the blockchain; and
executing, by the at least one processor, the action in the executable code in the block in the blockchain in response to receiving the trigger.

2. The method of claim 1, the generating further comprising:
selecting a token from a set of tokens based on the operationalized contract clause;
selecting a set of contract attributes defined for the operationalized contract clause;
modifying a code template associated with the operationalized contract clause based on the token and the set of contract attributes; and
compiling the code template into the executable code.

3. The method of claim 1, the generating further comprising:
generating the executable code for the blockchain based on a location condition associated with the operationalized contract clause.

4. The method of claim 1, the executing further comprising:
updating a database in response to receiving the trigger, wherein the updating is performed using an application programming interface (API) associated with the database.

5. The method of claim 1, the executing further comprising:
sending an email to a user in response to receiving the trigger.

6. The method of claim 1, the generating further comprising:
generating the executable code for the blockchain based on a time condition associated with the operationalized contract clause.

7. The method of claim 6, the executing further comprising:
transferring cryptographic data from a first entity to a second entity in response to receiving the trigger based on the time condition.

8. A system, comprising:
a memory; and
at least one processor coupled to the memory and configured to:
convert a static contract clause to an operationalized contract clause comprising a trigger and an action;
generate executable code for a blockchain based on the trigger and the action;
deploy the executable code on a block in the blockchain; and
execute the action in the executable code in the block in the blockchain in response to receiving the trigger.

9. The system of claim 8, wherein to generate the at least one processor is configured to:
select a token from a set of tokens based on the operationalized contract clause;
select a set of contract attributes defined for the operationalized contract clause;
modify a code template associated with the operationalized contract clause based on the token and the set of contract attributes; and
compile the code template into the executable code.

10. The system of claim 8, wherein to generate the at least one processor is configured to:
generate the executable code for the blockchain based on a location condition associated with the operationalized contract clause.

11. The system of claim 8, wherein to execute the at least one processor is configured to:
update a database in response to receiving the trigger, wherein the updating is performed using an application programming interface (API) associated with the database.

12. The system of claim 8, wherein to execute the at least one processor is configured to:
send an email to a user in response to receiving the trigger

13. The system of claim 8, wherein to generate the at least one processor is configured to:
generate the executable code for the blockchain based on a time condition associated with the operationalized contract clause.

14. The system of claim 13, wherein to execute the at least one processor is configured to:
transfer cryptographic data from a first entity to a second entity in response to receiving the trigger based on the time condition.

15. A non-transitory computer-readable device having instructions stored thereon that, when executed by at least one computing device, causes the at least one computing device to perform operations comprising:
converting a static contract clause to an operationalized contract clause comprising a trigger and an action;
generating executable code for a blockchain based on the trigger and the action;
deploying the executable code on a block in the blockchain; and
executing the action in the executable code in the block in the blockchain in response to receiving the trigger.

16. The non-transitory computer-readable device of claim 15, the generating comprising:
selecting a token from a set of tokens based on the operationalized contract clause;
selecting a set of contract attributes defined for the operationalized contract clause;
modifying a code template associated with the operationalized contract clause based on the token and the set of contract attributes; and
compiling the code template into the executable code.

17. The non-transitory computer-readable device of claim 15, the generating comprising:
generating the executable code for the blockchain based on a location condition associated with the operationalized contract clause.

18. The non-transitory computer-readable device of claim 15, the executing comprising:
updating a database in response to receiving the trigger, wherein the updating is performed using an application programming interface (API) associated with the database.

19. The non-transitory computer-readable device of claim 15, the executing comprising:
sending an email to a user in response to receiving the trigger.

20. The non-transitory computer-readable device of claim 15, the generating comprising:
generating the executable code for the blockchain based on a time condition associated with the operationalized contract clause.
